(19) United States
(12) Patent Application Publication
(10) Pub. No.: US 2019/0087419 A1
(43) Pub. Date: Mar. 21, 2019

(54) UPDATING METADATA OF OBJECTS IN A FILE SYSTEM

(71) Applicant: Hewlett Packard Enterprise Development LP, Houston, TX (US)

(72) Inventors: Venkataraman Kamalaksha, Bangalore (IN); Manoj Thankappan Varadamma, Bangalore (IN); Anand Satish Phatak, Bangalore (IN); Gaurav Gupta, Bangalore (IN)

(21) Appl. No.: 15/711,166

(22) Filed: Sep. 21, 2017

(51) Int. Cl. G06F 17/30

(52) U.S. Cl. CPC G06F 17/3007; G06F 17/3012; G06F 17/30156

(57) ABSTRACT

Some examples relate to updating of metadata of objects in a file system. In an example, in response to an invocation by an application to update metadata related to a plurality of objects of a file system, an API may initialize a new metadata deduplication database based on an active metadata deduplication database that includes the metadata related to the plurality of objects and a deduplication key linked with the metadata. API may add new metadata to the new metadata deduplication database. API may associate a new deduplication key with the new metadata in the new metadata deduplication database. API may initialize a new translation database. API may add the new deduplication key to the new translation database. API may associate the respective object IDs of the plurality of objects with the new deduplication key in the new translation database.

### BACKGROUND

A file system may be used to organize data on a storage device. A file system is generally an integral part of an operating system or may be installed separately as an extension of the operating system. It provides the underlying structure that a computing device uses to organize data on a storage medium.

### BRIEF DESCRIPTION OF THE DRAWINGS

The following detailed description references the drawings, wherein

FIG. 1 is a block diagram of an example device for updating metadata of objects in a file system;

FIG. 2 is a flow chart of an example method of updating metadata of objects in a file system; and

FIG. 3 is a block diagram of an example system including instructions in a machine-readable storage medium for updating metadata of objects in a file system.

### DETAILED DESCRIPTION

A file system may be used to control how data is stored and retrieved from a storage system. In an example, a computer file or “file” is the basic component of a file system. A file may contain data, such as text files, image files, video files, and the like, or it may be an executable file or program.

In an object-based file system, data (for example, a file) may be stored as a single object along with metadata, and is assigned an object ID. When the data is desired, the object ID may be presented to the system, which then fetches the data along with the metadata.

Adoption of technology by businesses has led to an explosion of data, which has resulted into a file system that may contain billions of objects, and each object may be associated with metadata. If an application (for example, a software update tool, a backup application, etc.) wants to update the metadata of a large number of file objects using standard file system semantics, the number of updates would be same as the number of file objects since the application may have to operate on each object separately. This may be undesirable as it may result in a large number of disk operations. It may be further undesirable, if multiple file objects share the same metadata (for example, an Access Control List (ACL)).

To address these technical challenges, the present disclosure describes various examples for updating metadata of object in a file system. In some examples, in response to an invocation by an application to update metadata related to a plurality of objects of a file system, an Application Programming Interface (API) may initialize a new metadata deduplication database based on an active metadata deduplication database that includes the metadata related to the plurality of objects and a deduplication key linked with the metadata. The deduplication key may map to respective objects IDs of the plurality of objects. New metadata related to the plurality of objects may be added to the new metadata deduplication database 116, and a new deduplication key may be associated with new metadata. Further, a new translation database based on an active translation database may be initialized. The active translation database may include a mapping between the deduplication key linked with the metadata and the respective object IDs of the plurality of objects. The new deduplication key may be associated with the respective object IDs of the plurality of objects in the new translation database. The API may be used to indicate the new metadata deduplication database 116 as default metadata deduplication database, and the new translation database as default translation database.

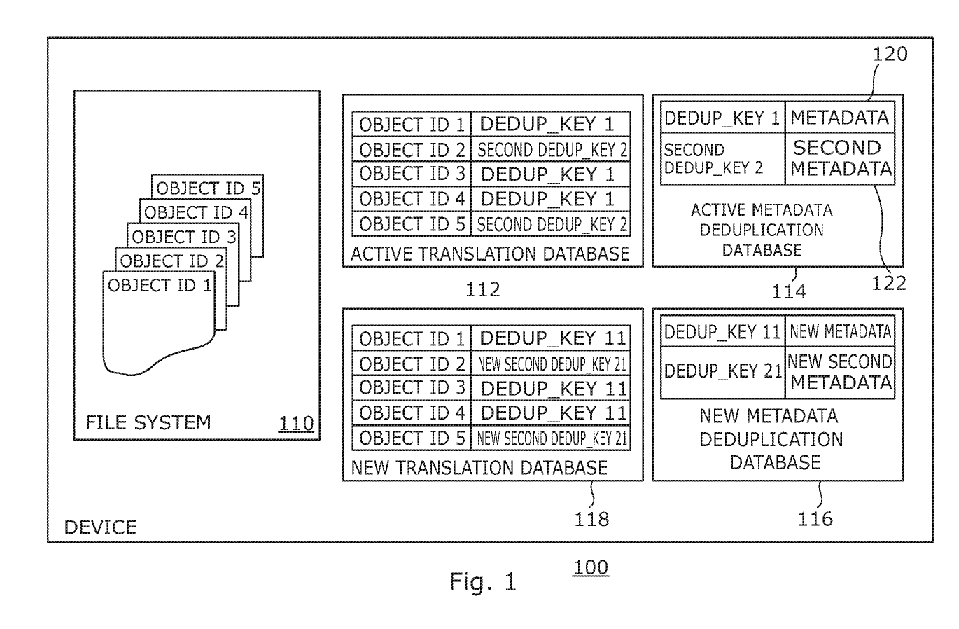

FIG. 1 is a block diagram of an example device 100 for updating metadata of object in a file system. In some examples, device 100 may represent any type of computing device capable of reading machine-executable instructions, for example, via a processor. Examples of the computing device may include, without limitation, a desktop computer, a notebook computer, a tablet computer, a server, a thin client, a mobile device, a personal digital assistant (PDA), and the like.

In an example, the machine-executable instructions may be present on a storage medium. The storage medium may be a primary storage device such as, but not limited to, random access memory (RAM), read only memory (ROM), processor cache, or another type of dynamic storage device that may store information and machine-readable instructions that may be executed by a processor. For example, Synchronous DRAM (SDRAM), Double Data Rate (DDR), Rambus DRAM (RDRAM), Rambus RAM, non-volatile memory (NVM), etc. In some examples, the storage medium may be a secondary storage device such as, but not limited to, a floppy disk, a hard disk, a CD-ROM, a DVD, a pen drive, a flash memory (e.g. USB flash drives or keys), a paper tape, an Iomega Zip drive, and the like. In some examples, the storage medium may include a Direct Attached Storage (DAS) device, a Network Attached Storage (NAS) device, a tape drive, a magnetic tape drive, a data archival storage system, or a combination of these devices.

In some examples, device 100 may include a file system 110. In some examples, file system 110 may be a journaling file system. Some non-limiting examples of a journaling file system may include like NTFS, Ext3, and Ext4.

In an example, file system 110 may represent an object-based file system comprising a plurality of objects. In an object-based file system, data (for example, a file) may be stored as a single object. An object may include data and metadata. An object may be identified via a globally unique identifier (or an “object ID”).

In an example, a plurality of objects in file system 110 may share the same metadata. In such case, the metadata may be de-duplicated. In other words, if more than one file object shares same metadata, only one copy of the metadata may be kept by file system 110. Objects that share the metadata are assigned a pointer to the shared metadata. In an example, the pointer includes a unique deduplication key that is linked to the unique copy of the metadata. Each object that shares the same metadata is associated with the unique deduplication key. In an example, the association may be carried out by mapping the respective object IDs of the objects to the unique deduplication key.

In an example, the mapping between an object ID of an object and an associated deduplication key may be stored in an active translation database 112. In an example, active translation database 112 may be present on device 100. In another example, active translation database 112 may be present on a device communicatively coupled to device 100. As illustrated in FIG. 1, in an example, active translation database 112 may include object IDs 1, 3, and 4 mapped to a deduplication key 1 (“dedup_key 1”), and object IDs 2 and 5 mapped to a second deduplication key 2 (“second dedup_key 2”). Each of the deduplication keys (dedup_key 1 and second dedup_key 2) may be linked to respective unique copies of metadata.

In an example, the mapping between a deduplication key and the associated metadata may be stored in an active metadata deduplication database 114. In an example, active metadata deduplication database 114 may be present on device 100. In another example, active metadata deduplication database 114 may be present on a device communicatively coupled to device 100. As illustrated in FIG. 1, in an example, active metadata deduplication database 114 may include deduplication key 1 mapped to metadata 120 and second deduplication key 2 mapped to second metadata 122. In an example, the metadata may include an access control list (ACL). The ACL may specify an access right (or permission) related to accessing of a file system object. The ACL may include a set of data (for example, a table) that informs a computer's operating system which permissions, or access rights, a user has to the file system object. The permissions determine specific access rights, such as whether a user can read from, or write to the file system object.

In an example, an application (for example, a software update tool, a backup application, etc.) may want to update metadata shared across a plurality of file objects. In such case, file system may provide access to both active translation database 112 and active metadata deduplication database 114 to the application, for example, through Application Programming Interfaces (APIs).

In an example, in order to update metadata (for example, ACL) related to a plurality of file objects, an application may invoke an API. In response to the invocation, the API may initialize a new metadata deduplication database 116 based on the active metadata deduplication database 114 that includes the metadata related to the plurality of objects and a deduplication key linked with the metadata. The deduplication key may map to respective objects IDs of the plurality of objects. In an example, initializing a new metadata deduplication database 116 may comprise initializing an empty new metadata deduplication database for the metadata to be updated. In an example, new metadata deduplication database 116 may be present on device 100. In another example, new metadata deduplication database 116 may be present on a device communicatively coupled to device 100.

Once the new metadata deduplication database 116 has been initialized, the API may be used to add new metadata related to the plurality of objects to the new metadata deduplication database 116. In an example, adding new metadata to the new metadata deduplication database 116 may comprise opening the active metadata deduplication database 114. Opening the active metadata deduplication database 114 may return a handle, which may be used to read a record (for example, a feature_ID) from the active metadata deduplication database 114 pointed by the handle. In an example, the record may relate to a deduplication key that maps to respective object IDs of the plurality of objects. The deduplication key may be linked to its unique copy of metadata. For example, dedup_key 1 is linked to metadata 120 in active metadata deduplication database 114. The API may be used to write a new record corresponding to the record associated with the deduplication key to add new metadata related to the plurality of objects to the new metadata deduplication database 116.

Once new metadata related to the plurality of objects has been added to the new metadata deduplication database 116, the API may be used to associate a new deduplication key (“dedup_key 11”) with new metadata in the new metadata deduplication database 116. In an example, the new deduplication key may be generated by file system 110. The new deduplication key also maps to the same object IDs of the plurality of objects to which the deduplication key mapped to.

Likewise, for each record in the active metadata deduplication database 114, a new record may be written to add corresponding new metadata to the new metadata deduplication database 116. And, for each new metadata added to the new metadata deduplication database 116, a corresponding new deduplication key may be associated therewith in the new metadata deduplication database 116. For example, in the context of FIG. 1, a new dedup_key 11 and a new second dedup_key 21 may be associated with metadata 120 and second metadata 122 in the new metadata deduplication database 116 respectively. In an example, the new second deduplication key may be generated by file system 110. Since, for each new metadata added to the new metadata deduplication database 116, a corresponding new deduplication key may be generated by file system 110, associating a new deduplication key with new metadata in the new metadata deduplication database may comprise identifying the new deduplication key that corresponds to the new metadata.

As mentioned earlier, the mapping between an object ID of an object and an associated deduplication key may be stored in an active translation database 112. In an example, the API may be used to initialize a new translation database 118 based on the active translation database 112. In an example, initializing a new translation database 118 may comprise initializing an empty new translation database for the metadata to be updated. In an example, new translation database 118 may be present on device 100. In another example, new translation database 118 may be present on a device communicatively coupled to device 100.

Once the new translation database 118 has been initialized, the API may be used to add new deduplication keys to the new translation database 118. In an example, adding new deduplication keys to the new translation database 118 may comprise opening the active translation database 112. Opening the active translation database 112 may return a handle, which may be used to read a record from the active translation database 112 pointed by the handle. In an example, the record may relate to an object ID of an object in the active translation database 112. The API may then be used to write a new record corresponding to the record to add the new deduplication key mapped to the object ID, to new translation database 118.

Once a new deduplication key (for example, dedup_key 11) has been added to the new translation database 118, the API may be used to associate the new deduplication key with the object IDs of the plurality of objects in the new translation database 118.

Likewise, for the new second metadata the API may be used to add the new second deduplication key (for example, dedup_key 21) to the new translation database 118. Once the new second deduplication key has been added to the new translation database 118, the API may be used to associate the respective object IDs of the second plurality of objects with the new second deduplication key in the new translation database 118.

Once the new metadata deduplication database 116 and the new translation database 118 have been updated with their respective data, as described earlier, API may be used to indicate the new metadata deduplication database as default metadata deduplication database, and the new translation database as default translation database. The active metadata deduplication database 114 and the active translation database 112 may be deleted.

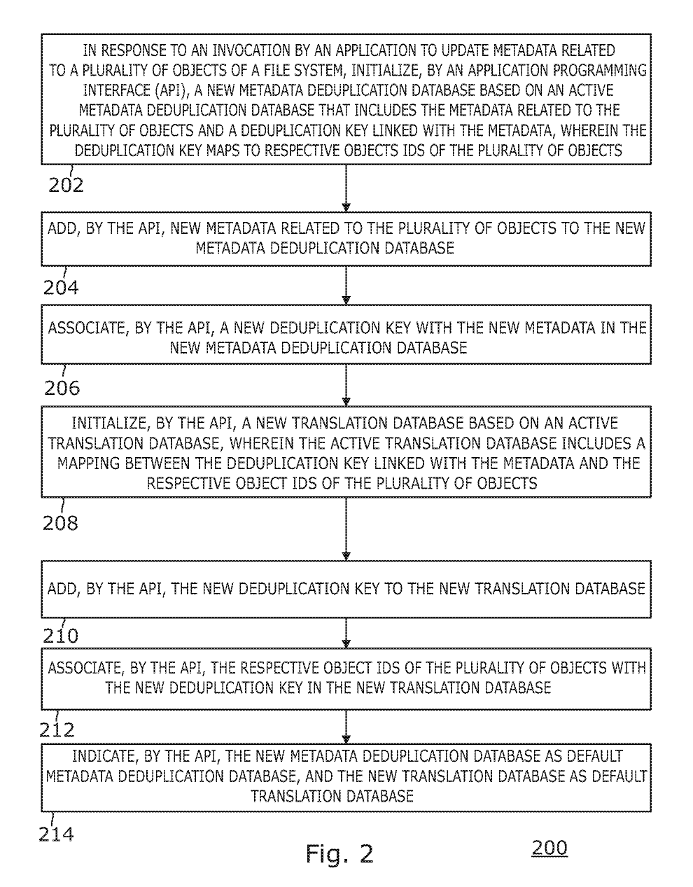

FIG. 2 is a flow chart of an example method 200 of updating metadata of objects in a file system. The method 200, which is described below, may be executed on a device such as device 100 of FIG. 1. However, other devices (for example, a computing device or a storage device) may be used as well. At block 202, in response to an invocation by an application to update metadata related to a plurality of objects of a file system, an Application Programming Interface (API) may initialize a new metadata deduplication database based on an active metadata deduplication database that includes the metadata related to the plurality of objects and a deduplication key linked with the metadata. The deduplication key may map to respective objects IDs of the plurality of objects. At block 204, the API may add new metadata related to the plurality of objects to the new metadata deduplication database. At block 206, the API may associate a new deduplication key with the new metadata in the new metadata deduplication database. At block 208, the API may initialize a new translation database based on an active translation database. The active translation database may include a mapping between the deduplication key linked with the metadata and the respective object IDs of the plurality of objects. At block 210, the API may add the new deduplication key to the new translation database. At block 212, the API may associate the respective object IDs of the plurality of objects with the new deduplication key in the new translation database. At block 214, the API may indicate the new metadata deduplication database as default active metadata deduplication database, and the new translation database as default active translation database.

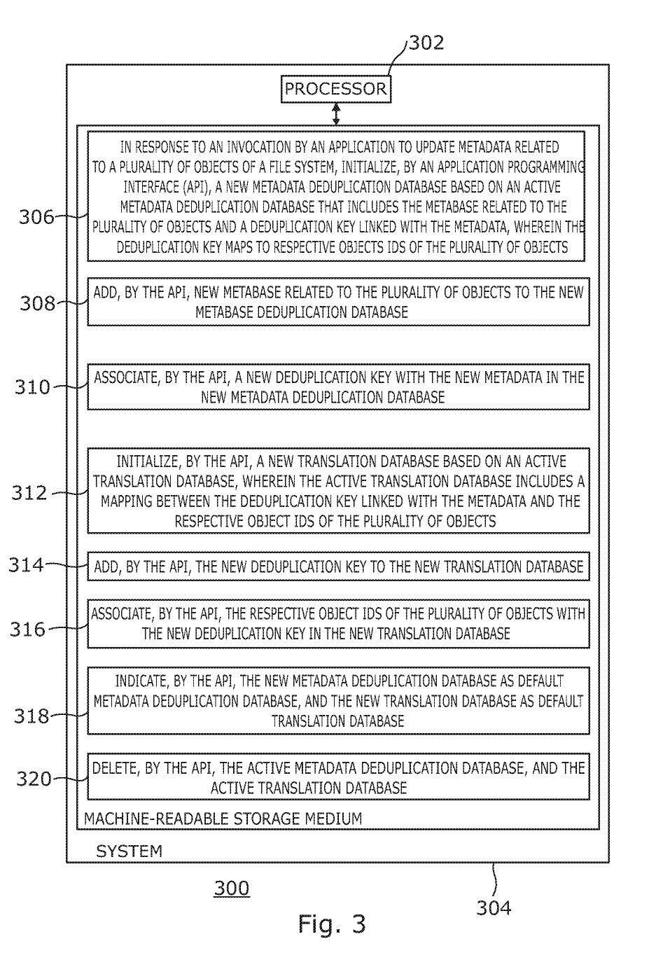

FIG. 3 is a block diagram of an example system 300 including instructions in a machine-readable storage medium 304 for updating metadata of objects in a file system. System 300 includes a processor 302 and a machine-readable storage medium 304 communicatively coupled, for example, through a system bus. Processor 302 may be any type of Central Processing Unit (CPU), microprocessor, or processing logic that interprets and executes machine-readable instructions stored in machine-readable storage medium 304. Machine-readable storage medium 304 may be a random access memory (RAM) or another type of dynamic storage device that may store information and machine-readable instructions that may be executed by processor 302. For example, machine-readable storage medium 304 may be Synchronous DRAM (SDRAM), Double Data Rate (DDR), Rambus DRAM (RDRAM), Rambus RAM, non-volatile memory (NVM), etc. or storage memory media such as a floppy disk, a hard disk, a CD-ROM, a DVD, a pen drive, and the like. In some examples, machine-readable storage medium 304 may be a non-transitory machine-readable medium. In some examples, machine-readable storage medium 304 may be remote but accessible to system 300.

Machine-readable storage medium 304 may store instructions 306, 308, 310, 312, 314, 316, 318, and 320. In some examples, instructions 306 may be executed by processor 302 to initialize, by an API, in response to an invocation by an application to update metadata related to a plurality of objects of a file system, a new metadata deduplication database based on an active metadata deduplication database that includes the metadata related to the plurality of objects and a deduplication key linked with the metadata. The deduplication key may map to respective objects IDs of the plurality of objects. Instructions 308 may be executed by processor 302 to add, by the API, new metadata related to the plurality of objects to the new metadata deduplication database. Instructions 310 may be executed by processor 302 to associate, by the API, a new deduplication key with the new metadata in the new metadata deduplication database. Instructions 312 may be executed by processor 302 to initialize, by the API, a new translation database based on an active translation database. The active translation database may include a mapping between the deduplication key linked with the metadata and the respective object IDs of the plurality of objects. Instructions 314 may be executed by processor 302 to add, by the API, the new deduplication key to the new translation database. Instructions 316 may be executed by processor 302 to associate, by the API, the respective object IDs of the plurality of objects with the new deduplication key in the new translation database. Instructions 318 may be executed by processor 302 to indicate, by the API, the new metadata deduplication database as default metadata deduplication database, and the new translation database as default translation database. Instructions 320 may be executed by processor 302 to delete, by the API, the active metadata deduplication database, and the active translation database.

For the purpose of simplicity of explanation, the example method of FIG. 2 is shown as executing serially, however it is to be understood and appreciated that the present and other examples are not limited by the illustrated order. The example systems of FIGS. 1, and 3, and method of FIG. 2 may be implemented in the form of a computer program product including computer-executable instructions, such as program code, which may be run on any suitable computing device in conjunction with a suitable operating system (for example, Microsoft Windows, Linux, UNIX, and the like). Embodiments within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, NVM, NVMe, NVRAM, NVDIMMs, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be understood that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

1. A method comprising:
in response to an invocation by an application to update metadata related to a plurality of objects of a file system, initializing, by an Application Programming Interface (API), a new metadata deduplication database based on an active metadata deduplication database that includes the metadata related to the plurality of objects and a deduplication key linked with the metadata, wherein the deduplication key maps to respective objects IDs of the plurality of objects;
adding, by the API, new metadata related to the plurality of objects to the new metadata deduplication database;
associating, by the API, a new deduplication key with the new metadata in the new metadata deduplication database;
initializing, by the API, a new translation database based on an active translation database, wherein the active translation database includes a mapping between the deduplication key linked with the metadata and the respective object IDs of the plurality of objects;
adding, by the API, the new deduplication key to the new translation database;
associating, by the API, the respective object IDs of the plurality of objects with the new deduplication key in the new translation database; and
indicating, by the API, the new metadata deduplication database as default metadata deduplication database, and the new translation database as default translation database.

2. The method of claim 1, further comprising:
adding, by the API, new second metadata related to a second plurality of objects to the new metadata deduplication database;
associating, by the API, a new second deduplication key with the new second metadata in the new metadata deduplication database, wherein the new second deduplication key maps to respective object IDs of the second plurality of objects;
adding, by the API, the new second deduplication key to the new translation database; and
associating, by the API, the respective object IDs of the second plurality of objects with the new second deduplication key in the new translation database.

3. The method of claim 2, wherein the active metadata deduplication database comprises second metadata related to the second plurality of objects and a second deduplication key linked with the second metadata.

4. The method of claim 3, wherein the active translation database includes a mapping between the second deduplication key linked with the second metadata and the respective object IDs of the second plurality of objects.

5. The method of claim 2, wherein the new second deduplication key is generated by the file system.

6. The method of claim 1, deleting, by the API, the active metadata deduplication database.

7. The method of claim 1, wherein associating the new deduplication key with the new metadata in the new metadata deduplication database comprises identifying the new deduplication key generated by the file system.

8. The method of claim 1, wherein the application includes a backup application.

9. A device comprising:
a processor; and
a storage medium comprising instructions to implement an Application Programming Interface (API), the instructions executable by the processor to:
initialize, by the API, in response to an invocation by an application to update metadata related to a plurality of objects of a file system, a new metadata deduplication database based on an active metadata deduplication database that includes the metadata related to the plurality of objects and a deduplication key linked with the metadata, wherein the deduplication key maps to respective objects IDs of the plurality of objects;
add, by the API, new metadata related to the plurality of objects to the new metadata deduplication database;
associate, by the API, a new deduplication key with the new metadata in the new metadata deduplication database, wherein the new duplication key is generated by the file system;
initialize, by the API, a new translation database based on an active translation database, wherein the active translation database includes a mapping between the deduplication key linked with the metadata and the respective object IDs of the plurality of objects;
add, by the API, the new deduplication key to the new translation database;
associate, by the API, the respective object IDs of the plurality of objects with the new deduplication key in the new translation database; and
indicate, by the API, the new metadata deduplication database as default metadata deduplication database, and the new translation database as default translation database.

10. The device of claim 9, wherein the new duplication key is generated by the file system.

11. The device of claim 9, further comprising instructions executable by the processor to delete, by the API, the active translation database.

12. The device of claim 9, wherein the application includes a data replication application.

13. The device of claim 9, wherein the instructions to initialize the new metadata deduplication database comprises instructions to initialize an empty metadata deduplication database based on the active metadata deduplication database.

14. A non-transitory machine-readable storage medium comprising instructions to implement an Application Programming Interface (API), the instructions executable by the processor to:
initialize, by the API, in response to an invocation by an application to update metadata related to a plurality of objects of a file system, a new metadata deduplication database based on an active metadata deduplication database that includes the metadata related to the plurality of objects and a deduplication key linked with the metadata, wherein the deduplication key maps to respective objects IDs of the plurality of objects;
add, by the API, new metadata related to the plurality of objects to the new metadata deduplication database;
associate, by the API, a new deduplication key with the new metadata in the new metadata deduplication database;
initialize, by the API, a new translation database based on an active translation database, wherein the active translation database includes a mapping between the deduplication key linked with the metadata and the respective object IDs of the plurality of objects;
add, by the API, the new deduplication key to the new translation database;
associate, by the API, the respective object IDs of the plurality of objects with the new deduplication key in the new translation database;
indicate, by the API, the new metadata deduplication database as default metadata deduplication database, and the new translation database as default translation database; and
delete, by the API, the active metadata deduplication database, and the active translation database.

15. The storage medium of claim 14, further comprising instructions to associate a new second deduplication key with the new second metadata in the new metadata deduplication database, wherein the new second deduplication key is generated by the file system.

16. The storage medium of claim 14, wherein the instructions to initialize the new translation database comprise instructions to initialize an empty translation database based on the active translation database.

17. The storage medium of claim 14, wherein the instructions to add the new metadata related to the plurality of objects to the new metadata deduplication database comprise instructions to:
read a record associated with the deduplication key that maps to respective object IDs of the plurality of objects from the active metadata deduplication database; and
write a new record corresponding to the record associated with the deduplication key to add the new metadata related to the plurality of objects to the new metadata deduplication database.

18. The storage medium of claim 14, wherein the instructions to add the new deduplication key to the new translation database comprise instructions to:
read the record associated with the deduplication key that maps to respective object IDs of the plurality of objects from the active translation database; and
write a new record corresponding to the record associated with the deduplication key to add the new deduplication key to the new translation database.

19. The storage medium of claim 14, further comprising instructions to delete the active metadata deduplication database.

20. The storage medium of claim 14, wherein the metadata includes an Access Control List (ACL).
